(19) United States
(12) Patent Application Publication
(10) Pub. No.: US 2003/0226807 A1
(43) Pub. Date: Dec. 11, 2003

(54) Method and apparatus for treating aqueous process baths and their associated waste streams

(76) Inventor: Jeff Watson, Pearland, TX (US)

Correspondence Address: Charles D. Gunter, Jr., Whitaker, Chald, Swindle & Sawyer, LLP, 3500 City Center Tower II, 310 Commerce Street, Ft. Worth, TX, 76102, US

(21) Appl. No.: 10/426,538

(22) Filed: Apr. 30, 2003

Related U.S. Application Data
(60) Provisional application No. 60/376,975, filed on May 1, 2002.

(51) Int. Cl. B01D 61/58

(52) U.S. Cl. 210/641; 210/650; 210/651; 134/109

(57) ABSTRACT

A method is shown for treating used aqueous based chemical baths such as are used in treating manufactured parts. The method splits a mixed stream of process chemicals, soils, oils, coolants, salts, and other contaminants into essentially four discrete streams: process chemicals, water, large particles such as dirt and oils, and salts or other low molecular weight contaminants. Certain of the process streams provide for return of process chemicals to their respective tanks and for the return of decontaminated rinse waters to their respective processes. Contaminants removed by the method are segregated and passed on to other processes for further treatment or disposal.

### 1. CROSS-REFERENCE TO RELATED APPLICATIONS

Benefit is herein claimed of the filing date under 35 U.S.C. §§ 119 and/or 120, and 37 C.F.R. § 1.78 to U.S. provisional patent application serial No. 60/376,975, filed on May 1, 2002, and entitled “Method and Apparatus for Treating Aqueous Process Chemicals and Associated Rinse Waters.”

### FIELD OF THE INVENTION

The present invention relates generally to a method and apparatus for treating aqueous process baths used in preparation of manufactured parts for painting, powder coating, or other finishing, and to eliminating the associated waste streams from these aqueous processes containing residue of process chemicals.

### BACKGROUND OF THE INVENTION

Aqueous process chemical baths such as those used in the preparation of manufactured parts for subsequent coating operations typically are built up from various proprietary products in any of several categories. Such categories include acidic cleaners, alkaline cleaners, Iron, Zinc, Chrome, Manganese, and other phosphate conversion coatings, and many other materials serving different utility in the process. These solutions are known to be effective in removing oil, grease, soils and other contaminants from manufactured or processed parts and further preparing them for subsequent coating operations. For example, process chemicals including alkaline cleaners, acidic cleaners, solvent cleaners and any of several other commonly used cleaning materials are used as “pre-paint” washes for appliance parts such as range hoods or laundry machine housings, and the various phosphate conversion coatings and non-phosphate treatments are used for further preparing manufactured parts to accept organic coatings such as paint and powder coatings.

Various types of cleaning apparatus have been proposed including a series of wash and rinse tanks, sometimes referred to as a “dip-tank” system, and the spray wash system. In a typical dip tank system, a rack-mounted component is treated with various aqueous cleaner solutions and associated rinsing steps in a series of tanks. An alternative process is the spray wash system, which consists of a tunnel containing spray nozzles that spray the work piece with various process chemicals and rinses as the parts move through the tunnel. A series of tanks below the tunnel collect the aqueous effluent at various points, returning the various solutions to their respective tanks. An alternative spray wash process is the “pressure washer” application wherein process chemicals and rinses are applied using a hand-held or robotic sprayer and all the effluent is allowed to fall to the same receiving tank, pit or trench. For the purposes of the invention process and waste streams emanating from dip tank processes and spray wash processes will be treated as equivalent.

A typical aqueous process fluid will comprise a water base, which may contain various active ingredients such as surfactants, defoamers, rust inhibitors, phosphate compounds, polymers or other cleaning, passivating, or coating agents. These additives, which are present in the water base fluid, are expensive ingredients and add significantly to the cost of the operation. Additionally, these ingredients are not typically readily degradable in the environment, thereby presenting disposal problems. Extension of bath life and recovery of these materials is therefore of great interest to businesses employing such processes.

It is accordingly an object of the present invention to provide a method of treating a mixed stream of aqueous process chemical stream and its associated rinse water.

Another object of the invention is to provide a method which will allow the return of the process chemical back to the process operation as well as returning the rinse water back to the rinsing operation in a condition such that it is beneficial to the process.

Another object of the invention is to provide a method for effectively removing oils, salts, emulsified materials, and other contaminants. These components will be sent to a separate system for further treatment or disposal, the useable process chemical components and decontaminated rinse water being returned to the process for re-use.

Another object of the invention is to provide a method for effectively extending the life of process baths by removing contaminants continually and by selective removal of spent or otherwise useless materials in the process bath.

Another object of the invention is to provide a method for effectively removing soluble heavy metals and their salts from wastewater streams, rendering such streams harmless to the environment insofar as heavy metals are concerned.

### SUMMARY OF THE INVENTION

A method is shown for treating an incoming stream containing aqueous process chemicals and associated rinse waters, separating the stream into reusable constituents and segregating the contaminants for further treatment or disposal. In the first step of the method, an incoming stream is filtered using a simple particle filtration to remove large contaminants having particle sizes generally greater than about 5 microns. A second step separates the stream into two discrete parts, one part containing a small portion of the aqueous stream and all constituents with molecular weights generally above about 5000. The other part having the bulk of the aqueous portion of the stream and all constituents with molecular weights generally below about 5000.

The third step in the method of the invention is the further separation of the stream described above as having the bulk of the aqueous portion of the stream and all constituents having molecular weights generally below about 5000. This third step involves a permeable membrane separation done below the osmotic pressure of the solution being treated. This separation made so that the stream is divided into a concentrate stream having a small portion of the aqueous stream and a high percentage of the constituents with molecular weights generally above 200, and a permeate stream having the bulk of the water portion of the stream and all salts and other contaminants with molecular weights generally below 200.

The concentrate stream from the above step, containing some water and the bulk of the recovered chemical bath constituents, is returned to the appropriate aqueous process bath for reuse. The permeate stream from the above step consists of water and contaminants such as salts which, within the scope of the invention, have no value for reuse in the aqueous process bath.

The fourth and final step in the method of the invention is to further separate the above described permeate stream into two discrete parts using a permeable membrane at pressure above the osmotic pressure of the solution. This final membrane separation is commonly referred to as reverse osmosis and will divide the solution into a permeate stream essentially free of contaminants, and a concentrate stream having approximately twenty percent of the water and generally 96-99.5 percent of the salts and other contaminants. The permeate stream from this last step is returned to the original process to be used for rinsing or for make-up water, and the concentrate stream is sent to a separate process for further treatment or disposal.

Additional objects, features, and advantages will become apparent in the written description which follows.

### BRIEF DESCRIPTION OF THE DRAWINGS

FIG. 1 is a flow chart illustrating the various steps in the method of the invention.

FIGS. 2-6 are simplified schematic views of various spray wash arrangements utilizing the method of the invention.

FIG. 7 is a simplified illustration of the process outlined in the method of the invention, as it would apply to a representative process stream.

### DETAILED DESCRIPTION OF THE PREFERRED EMBODIMENTS

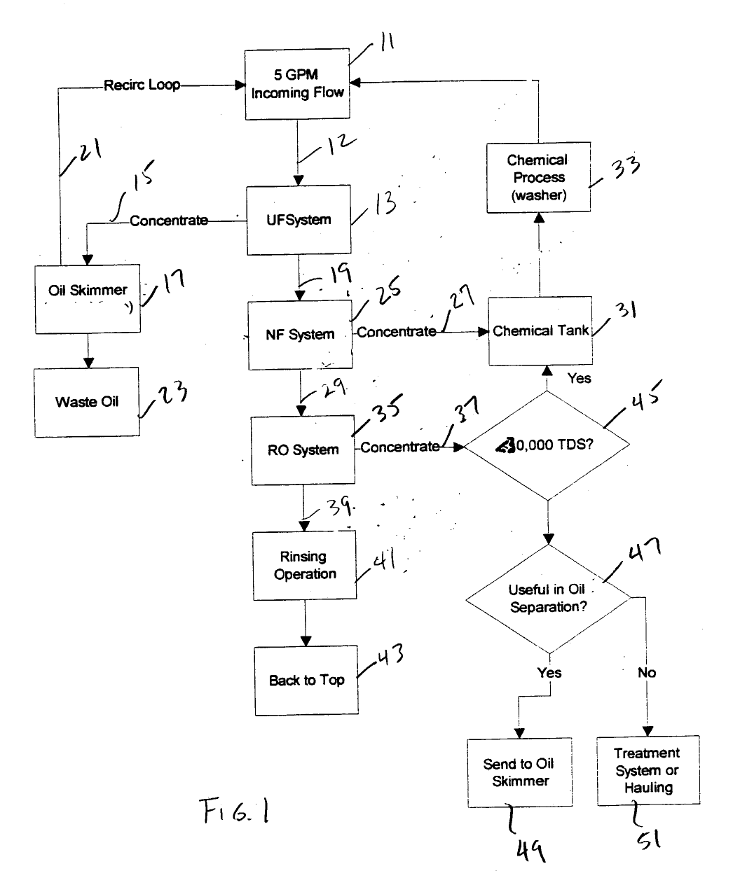

Turning to FIG. 1, the various steps in the method of the invention are illustrated in the form of a flow chart. In the preferred embodiment of the invention illustrated in FIG. 1, an incoming stream of aqueous process chemicals and associated rinse water enters the system as shown in block 11. The bulk of the incoming stream is supplied from the aqueous chemical process shown (33). The incoming flow from block 11 is first filtered with particulate filters in stages resulting in a stream containing no particulate contaminate larger than about 1 micron.

The stream (12) is then passed through a permeable membrane (13) capable of separating particles with molecular weights generally above 5000 depending on the specific membrane material chosen, commonly referred to as Ultrafiltration. The high molecular weight stream from this separation is referred to as the “concentrate” and the part of the original stream permeating through the membrane is referred to as the “permeate” stream. This separation occurs at relatively low pressure, generally around 50 to 100 psi

The concentrate stream from the above step (15) is directed to a separate process for further treatment or disposal. The further treatment shown on the flow chart is an oil separation step commercially available in many forms. In this case, the oil separation step includes an oil skimmer (17) which separates waste oil (23) from the recirculated product as shown in the loop (21).

The permeate stream from the above step (19) is directed to a further separation by a permeable membrane (25) having a much lower molecular weight cutoff in the range of 150 to 1000, commonly referred to as nanofiltration. The membrane is chosen based on the molecular weight of the materials being recovered for recycling. This separation occurs below the osmotic pressure of the solution so that salts in solution in the stream are generally left in solution and permeated through the membrane with the bulk of the water.

The concentrate stream from the above step (27) is directed back to the appropriate aqueous process tank for reuse or to a holding tank for storage until the process must be replenished. In the example shown in the flowchart of FIG. 1, the concentrate stream (27) passes to a chemical tank (31) and to the chemical process washer (33).

The permeate stream from the above step (29) is directed to a further separation by a semi-permeable membrane having a still lower molecular weight cutoff generally between 80 and 150. This final separation (35) is done at a pressure higher than the osmotic pressure of the solution and is commonly referred to as Reverse Osmosis. This step separates the bulk of the water from the original stream from the salts that are in solution within it. The separation of these salts is critical to the conditioning of the water for reuse as a rinsing material for the aqueous processes preceding it.

The concentrate stream from the above step (37) is directed to various areas based on logic and controls that vary with the process, as shown in the logic step (45). If the salt-laden water is useful in replenishing the process tanks it can be used there. If the contaminated stream is useless it is directed to a separate process for further treatment or disposal. This further treatment could, as an example, be an evaporation process to dewater the stream, rendering it a solid waste much easier and less costly to dispose of. In the flowchart of FIG. 1, the concentrate stream from the logic step (45) is analyzed as either being useful for oil separating or not in a step (47). The useful stream (49) is sent to the skimmer while the non-useful stream passes to a further treatment system (51) or for hauling.

The permeate stream from the above step (39) is generally sent directly back to a rinsing operation to provide clean water for rinsing and to provide dilution water for the rinse tanks.

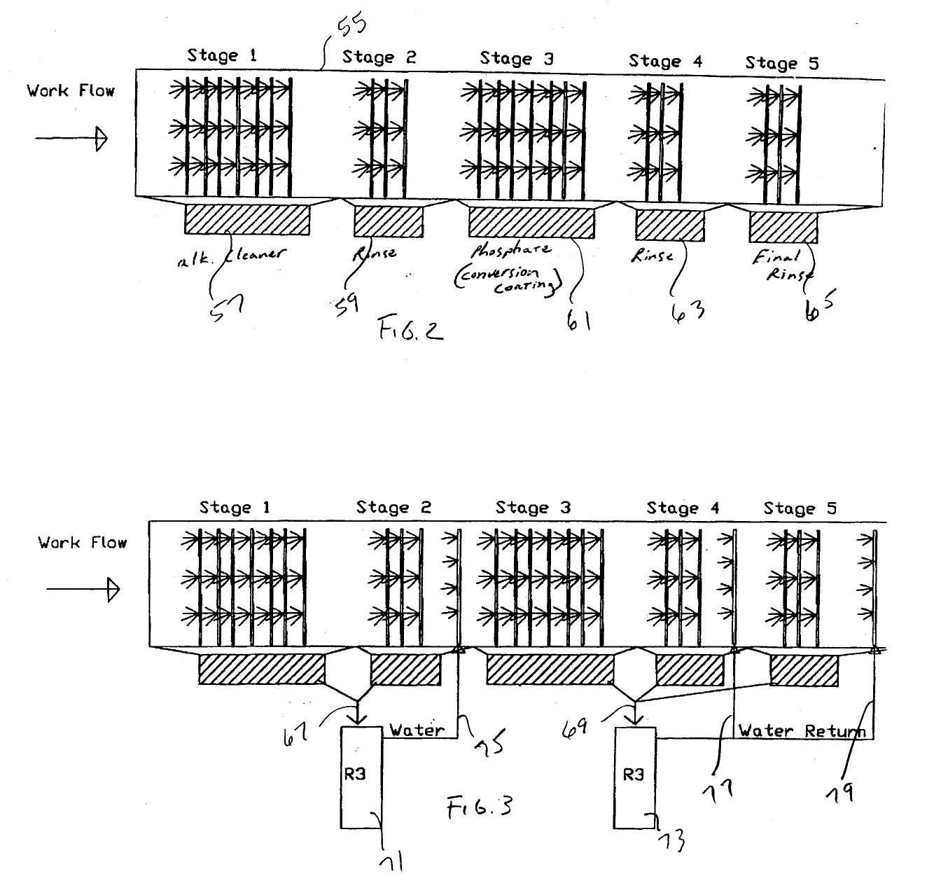

FIGS. 2-6 illustrate the general arrangement envisioned for the invention as it would apply to a five-stage spray wash process common in the organic finishing industry for manufactured parts of various substrates.

FIG. 2 illustrates a generic five-stage spray wash process (55) utilizing aqueous process chemicals in stages one (57) and three (61), and utilizing stages two (59), four (63), and five (65) for rinsing.

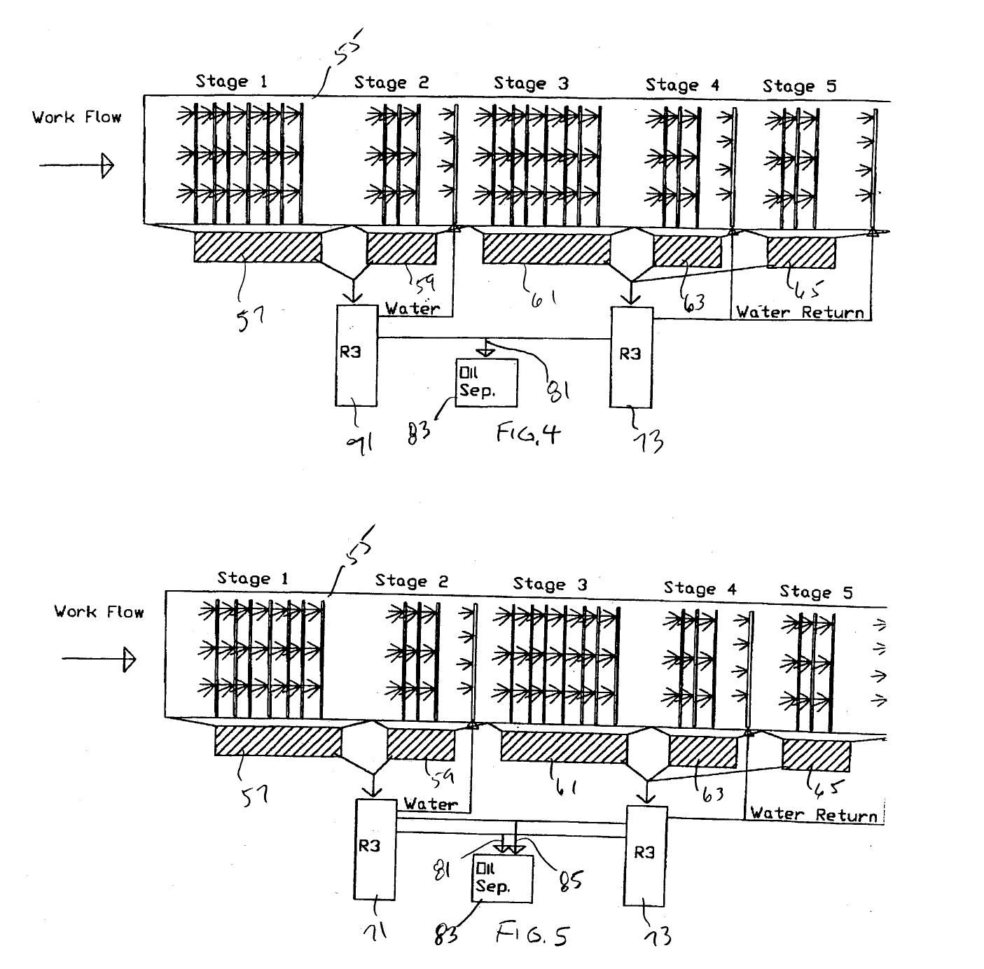

FIG. 3 illustrates the process described in FIG. 2 with the addition of with the effluent lines (67, 69) being shown which are used to pass the process effluent to a pair of units (71, 73) which are each individual units employing the methods outlined here to recover separate process chemical baths. The two treatment units (71, 73) supply the final permeate stream of clear rinse water described in the summary above, returning the water to the process via lines (75, 77, 79) connected to nozzles at the end of each rinse stage. These final rings of nozzles spraying clean rinse water are commonly referred to as “halos” and are the most effective method of applying the cleanest rinse water available to the work pieces as they travel through the process.

FIG. 4 illustrates the process of FIG. 3 with the addition of line 81 illustrating the first concentrate stream described above as having molecular weights generally above 5000 being passed to an oil separation process (83) for further treatment and eventual disposal.

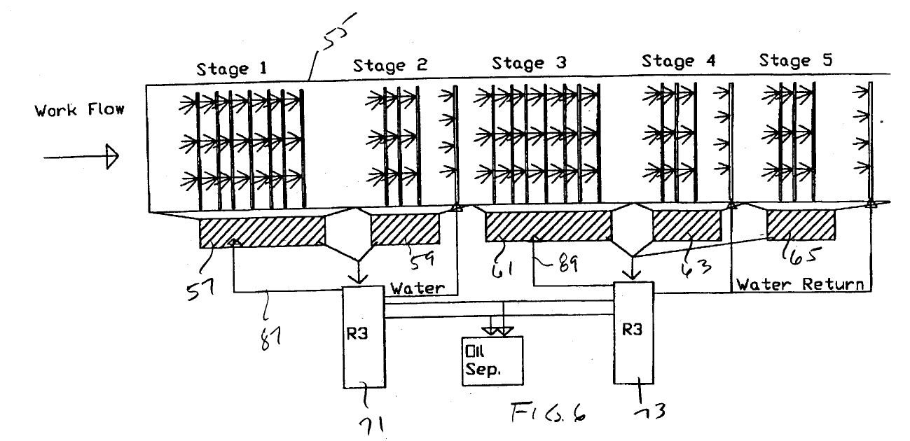

FIG. 5 illustrates the process of FIG. 4 with the addition of line 85 illustrating the salt laden stream from the final concentrate stream being passed to the oil separation process to aid in emulsion breaking. This use of the final concentrate stream is illustrative only and would depend on the constituents involved whether this would be a beneficial use of that stream.

FIG. 6 illustrates the process of FIG. 5 with the addition of lines 87 and 89 showing the return flow of recovered process chemicals to their respective tanks.

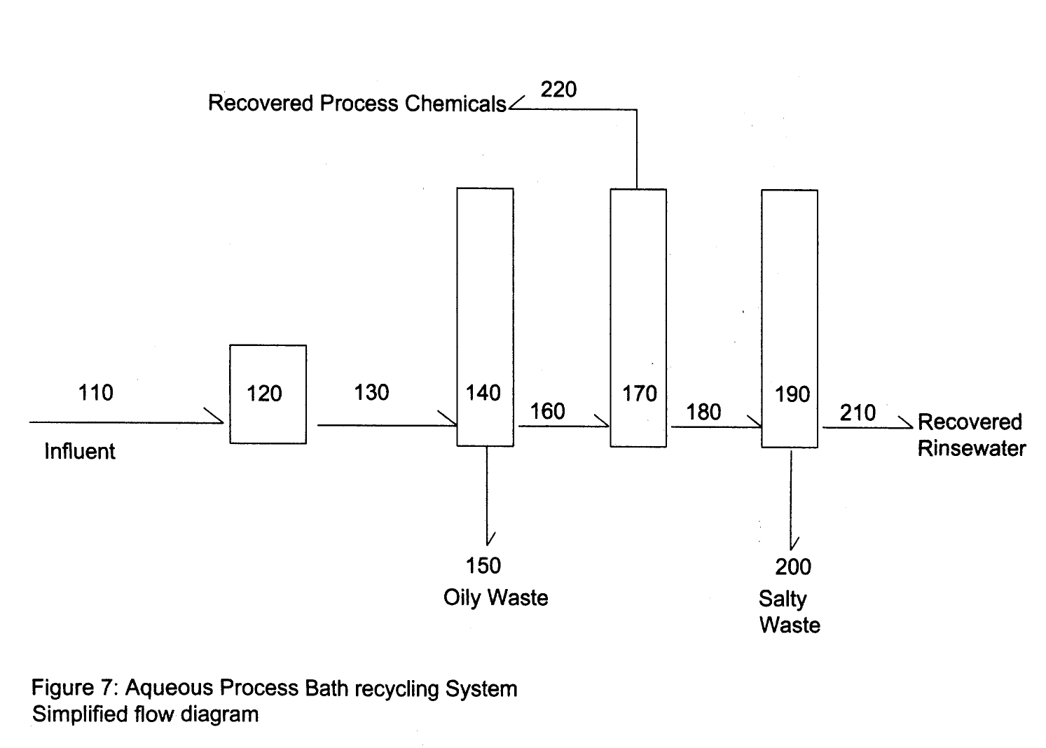

FIG. 7 illustrates a generic flow schematic of the invention without any other processes shown. An influent stream (110) is pumped into a particulate filter (120), removing particulate soils generally larger than 5 microns. The filtered influent stream (130) is pumped to the first membrane separation (140), where the stream is separated into concentrate stream (150) having a small portion of the water from the stream and effectively all the contaminants of particle size larger than about 5000 molecular weight, and a permeate stream (160) which is then pumped to the second membrane separation (170). The second separation (170) is carried out at a pressure below the osmotic pressure of the solution and using a permeable membrane yielding a concentrate stream (220) of a portion of the aqueous base and most of the aqueous process chemicals in the molecular weight range between 200 and 5000, and a permeate stream (180) of the bulk of the water and effectively all of the soluble contaminants having molecular weights below the molecular weight cutoff of the membrane, generally below about 200. This permeate stream (180) is then pumped via a high-pressure pump to the final semi-permeable membrane separation (190), which occurs above the osmotic pressure of the soluble contaminants in the solution. This final separation yields a concentrate stream (200) of a small portion of the water from the stream and greater than 96% of the salts and other dissolved contaminants, and a permeate stream (210) of effectively pure water recovered for rinsing or other operations.

An invention has been provided with several advantages. The method of the invention provides an economical and cost effective means for treating aqueous process chemical baths and associated rinse waters and for separating them into streams of reusable or easily treatable constituent streams. The method is particularly well suited for use with aqueous processes of the type typically used in the organic finishing of manufactured parts. Because the method recovers the process chemicals from contaminants such as salts, sludge, and oils, the useful life of the aqueous process bath is greatly extended offering great value to the user. The inventive method is particularly intended to be used in processes where the method of application is a spray wash, rather than immersion. The inventive method treats the effluent streams as one and is intended to treat any aqueous process solution, not specifically cleaner or soap based solutions as in the prior art.

The inventive method splits a mixed stream of process chemicals, soils, oils, coolants, salts, and other contaminants into essentially four discrete streams: process chemicals, water, large particles such as dirt and oils, and salts or other low molecular weight contaminants. The invention provides an effective method for return of process chemicals to their respective tanks and for the return of decontaminated rinse waters to their respective processes. Contaminants removed by the method are segregated and passed on to other processes for further treatment or disposal.

While the invention is shown in only one of its forms, it is not thus limited but is susceptible to various changes and modifications without departing from the spirit thereof. The various steps described in the method of the invention, along with the pumps, controls, and other ancillary equipment are intended to reside in one chassis and to be centrally controlled so that all separation processes work at flow rates balancing the flows throughout the process.

I claim:

1. A process for treating a used chemical bath comprised of an aqueous base and aqueous process chemicals, the used chemical bath being used in the preparation of manufactured parts, the process comprising the steps of:
directing an influent stream of a used, aqueous based chemical bath into a particulate filter capable of removing particulates larger than about 5 microns;
passing the filtered influent stream to a first membrane separation unit where the stream is separated into a first concentrate stream having a small portion of the water from the stream and effectively all of the contaminants of particle size larger than about 5000 molecular weight, and a first permeate stream;
passing the first permeate stream to a second membrane separation unit where the permeate is separated to yield a second concentrate stream of a portion of the aqueous base and a majority of the aqueous process chemicals in the molecular weight range between about 200 and 5000, and a second permeate stream of the bulk of the water and effectively all of the soluble contaminants having molecular weights below the molecular weight cutoff of the membrane;
passing the second permeate stream to a final membrane unit for filtration, thereby yielding a third concentrate stream of a small portion of water from the stream and the majority of the salts and other dissolved contaminants, and a final permeate stream of effectively pure water recovered for rinsing or other operations.

2. A process for treating a used chemical bath comprised of an aqueous base and aqueous process chemicals, the used chemical bath being used in the preparation of manufactured parts, the process comprising the steps of:
directing an influent stream of a used, aqueous based chemical bath into a particulate filter capable of removing particulates larger than about 5 microns;
passing the filtered influent stream to a first membrane separation unit where the stream is separated into a first concentrate stream having a small portion of the water from the stream and effectively all of the contaminants of particle size larger than about 5000 molecular weight, and a first permeate stream;
passing the first permeate stream to a second membrane separation unit where the permeate is separated at a pressure below the osmotic pressure of the stream and using a permeable membrane to yield a second concentrate stream of a portion of the aqueous base and a majority of the aqueous process chemicals in the molecular weight range between about 200 and 5000, and a second permeate stream of the bulk of the water and effectively all of the soluble contaminants having molecular weights below the molecular weight cutoff of the membrane, generally below about 200;
passing the second permeate stream to a final semi-permeable membrane unit for filtration, the filtration occurring above the osmotic pressure of the soluble contaminants in the second permeate stream, thereby yielding a third concentrate stream of a small portion of water from the stream and greater than 96% of salts and other dissolved contaminants, and a final permeate stream of effectively pure water recovered for rinsing or other operations.

3. The process of claim 2, wherein the chemical bath is used in the organic finishing of manufactured parts for subsequent coating operations by painting, powder coating or other coating steps.

4. The process of claim 2, wherein chemical bath is applied as a spray wash, rather than an immersion.

5. The process of claim 4, wherein the spray wash includes a spray tunnel and wherein the tunnel contains spray nozzles that spray a work piece with various process chemicals and rinses as the workpiece moves through the tunnel, effluent from the process being collected in a series of collections tanks located below tunnel.

6. The process of claim 4, wherein the process chemicals and rinses are applied to a part using hand-held or robotic sprayers with the effluent being allowed to fall to a receiving tank.

7. The process of claim 2, wherein the aqueous process bath contains, in addition to water, additional ingredients selected from the group consisting of:
acidic cleaners, alkaline cleaners, surfactants, defoamers, rust inhibitors, phosphate conversion coatings and additional cleaning, passivating and coating agents.
